(19) United States
(12) Patent Application Publication
(10) Pub. No.: US 2010/0315573 A1
(43) Pub. Date: Dec. 16, 2010

(54) LIQUID CRYSTAL PANEL, APPLICATION AND MANUFACTURING METHOD THEREOF

(75) Inventors: Chih-Yung HSIEH, Miao-Li County (TW); Rung-Nan LU, Miao-Li County (TW)

Correspondence Address: LOWE HAUPTMAN HAM & BERNER, LLP, 1700 DIAGONAL ROAD, SUITE 300, ALEXANDRIA, VA, 22314, US

(73) Assignee: CHI MEI OPTOELECTRONICS CORP., Tainan County (TW)

(21) Appl. No.: 12/813,162

(22) Filed: Jun. 10, 2010

(30) Foreign Application Priority Data
Jun. 11, 2009 (TW) 98119548

(51) Int. Cl. G02F 1/1335; G02F 1/1339

(52) U.S. Cl. 349/61; 349/155

(57) ABSTRACT

A liquid crystal panel, an application and a manufacturing method are described. The liquid crystal panel includes a transistor substrate including a plurality of data lines, a color filter disposed on the transistor substrate, a liquid crystal layer disposed between the transistor substrate and the color filter, and a plurality of spacer structures respectively disposed between the data lines and the color filter.

### CROSS-REFERENCE TO RELATED APPLICATIONS

The present application claims priority of TW 98119548 filed on Jun. 11, 2009 which is incorporated herein by reference in its entirety.

### TECHNICAL FIELD

The present disclosure relates to a liquid crystal panel, and more particularly to a liquid crystal panel of high display quality.

### BACKGROUND

As liquid crystal panels become larger or operation frequencies of liquid crystal panels become higher the following effect shown in FIG. 1A-B becomes apparent. In a display frame 102a of a liquid crystal panel 100 with a uniform gray scale display condition as shown in FIG. 1A, the frame brightness is uniform. In other display conditions, however, the frame brightness may not be uniform. For example, in a display frame 102b of the liquid crystal panel 100 in a window display condition that has a higher brightness area in the center 104, as shown in FIG. 1B an external rim region 108 below a white frame of a window region 104 is darker than other external rim regions 110, so that the brightness of the frame outside of the higher brightness area 104 is nonuniform. The nonuniform brightness phenomenon of the frame results because of the variation of the liquid crystal material above data lines with the frame differences.

Referring to FIG. 2A and FIG. 2B. FIG. 2A and FIG. 2B are schematic diagrams respectively showing display frames of a liquid crystal panel in a gray scale display condition and in a window display condition. The liquid crystal panel 100 includes a thin film transistor substrate 112, a color filter 114, and liquid crystal material 116 located in between the thin film transistor substrate 112 and the color filter 114. The thin film transistor substrate 112 includes a substrate 118, an isolation layer 120 disposed on a surface of the substrate 118, data lines 124 disposed within the isolation layer 120, and an indium tin oxide (ITO) layer 122 disposed on the isolation layer 120. In addition, the color filter 114 includes a substrate 126, a black matrix layer 128 and a color resist layer 130 disposed on a surface of the substrate 126, and an indium tin oxide layer 132 disposed on the black matrix layer 128 and the color resist layer 130.

It is observed from FIG. 2A and FIG. 2B that the white frame of the window region 104 requires a larger voltage, so that in comparison with the liquid crystal material 116 above the data lines 124 in the gray scale display frame 102a, a larger voltage is applied to the liquid crystal material 116 above the data lines 124 in the window region 104. Therefore, the molecules of the liquid crystal material 116 above the data lines 124 in the window region 104 in the display frame 102b have larger inclined angles, and the molecules of the liquid crystal material 116 above the data lines 124 in the gray scale display frame 102a have smaller inclined angles. The liquid crystal element has different dielectric permittivities in the different directions, and the dielectric permittivity is typically divided into components of two directions, including ε// (the component parallel to the electric field) and ε⊥ (the component perpendicular to the electric field). When the component ε// is greater than the component ε⊥, the dielectric permittivity anisotropy of the liquid crystal is referred as a positive type, and the liquid crystal is usually applied to a twisted nematic (TN) type liquid crystal display. When the component ε// is less than the component ε⊥, the dielectric permittivity anisotropy of the liquid crystal is referred as a negative type, and the liquid crystal is usually applied to a vertical alignment (VA) type liquid crystal display. When the liquid crystal display uses the negative liquid crystal material, according to the characteristic of the negative liquid crystal, as the inclination angle of the liquid crystal 116 becomes larger, the dielectric permittivity ε of the liquid crystal element becomes larger, and the capacitance of the liquid crystal 116 becomes larger. As a result, the RC delay situation is more critical, especially for the external rim region 108 corresponding to the terminals of the data lines 124. Due to the RC delay, the charging characteristic of the pixels in the external rim region 108 of the display frame 102b in the window display condition deteriorates, so that the external rim region 108 below the window region 104 is darker. Phenomenon such as that described above are becoming more apparent as liquid crystal panels is become larger or as the operation frequencies of liquid crystal panels become higher.

### SUMMARY

Therefore, one aspect of the present disclosure is to provide a liquid crystal panel and its application to a liquid crystal display, in which a plurality of spacer structures are disposed between data lines of a transistor substrate of the liquid crystal panel and a color filter.

Another aspect of the present disclosure is to provide methods for manufacturing a liquid crystal panel and a liquid crystal display, in which a plurality of spacer structures are disposed between data lines of a transistor substrate of the liquid crystal panel and a color filter, or on color resist layers above data lines of an integrated color filter.

Another aspect of the present disclosure is to provide a liquid crystal panel and its application to a liquid crystal display, in which a plurality of spacer structures are disposed on a plurality of color resist layers above a plurality of data lines of a transistor substrate of the liquid crystal panel.

Another aspect of the present disclosure is to provide methods for manufacturing a liquid crystal panel and its application to a liquid crystal display, in which a plurality of spacer structures are disposed on a plurality of color resist layers above a plurality of data lines of a transistor substrate of the liquid crystal panel.

According to the aforementioned aspects, the present disclosure provides a liquid crystal panel, including a transistor substrate including a plurality of data lines, a color filter disposed on the transistor substrate, a liquid crystal layer disposed between the transistor substrate and the color filter and a plurality of spacer structures respectively disposed between the data lines and the color filter.

According to the aforementioned aspects, the present disclosure provides a method for manufacturing a liquid crystal panel, including providing a transistor substrate, wherein the transistor substrate includes a plurality of data lines, disposing a color filter on the transistor substrate, disposing a liquid crystal layer between the transistor substrate and the color filter and disposing a plurality of spacer structures respectively between the data lines and the color filter.

According to the aforementioned aspects, the present disclosure provides a liquid crystal panel, including a transistor substrate with a plurality of data lines, a plurality of color resist layers above the plurality of data lines, a plurality of spacer structures disposed over the plurality of data lines and the plurality of color resist layers, and a liquid crystal layer disposed on the plurality of color resist layers and the plurality of spacer structures.

According to the aforementioned aspects, the present disclosure provides a method for manufacturing a liquid crystal panel, including providing a transistor substrate, wherein the transistor substrate includes a plurality of data lines, disposing a plurality of color resist layers above the plurality of data lines, disposing a plurality of spacer structures over the plurality of data lines and the plurality of color resist layers, and disposing a liquid crystal layer on the plurality of color resist layers and the plurality of spacer structures.

### BRIEF DESCRIPTION OF THE DRAWINGS

The foregoing aspects and many of the attendant advantages of this disclosure are more readily appreciated as the same become better understood by reference to the following detailed description, when read in conjunction with the accompanying drawings, wherein:

FIG. 1A is a schematic diagram showing a display frame of a conventional liquid crystal panel in a gray scale display condition;

FIG. 1B is a schematic diagram showing a display frame of a conventional liquid crystal panel in a window display condition;

FIG. 2A illustrates a cross-sectional view of a liquid crystal panel in a gray scale display condition;

FIG. 2B illustrates a cross-sectional view of a liquid crystal panel in a window display condition;

FIG. 3A through FIG. 3H are schematic flow diagrams showing a process for manufacturing a liquid crystal display in accordance with a first preferred embodiment of the present disclosure;

FIG. 4A through FIG. 4E are schematic flow diagrams showing a process for manufacturing a liquid crystal display in accordance with a second preferred embodiment of the present disclosure;

FIG. 5A through FIG. 5E are schematic flow diagrams showing a process for manufacturing a liquid crystal display in accordance with a third preferred embodiment of the present disclosure;

FIG. 6A through FIG. 6D are schematic flow diagrams showing a process for manufacturing a liquid crystal display in accordance with a fourth preferred embodiment of the present disclosure;

FIG. 7A through FIG. 7E are schematic flow diagrams showing a process for manufacturing a liquid crystal display in accordance with a fifth preferred embodiment of the present disclosure;

FIG. 8 illustrates a cross-sectional view of a liquid crystal display in accordance with a sixth preferred embodiment of the present disclosure;

FIG. 9A is a schematic diagram showing a disposition of spacer structures in accordance with an embodiment of the present disclosure; and

FIG. 9B is a schematic diagram showing a disposition of spacer structures in accordance with an embodiment of the present disclosure.

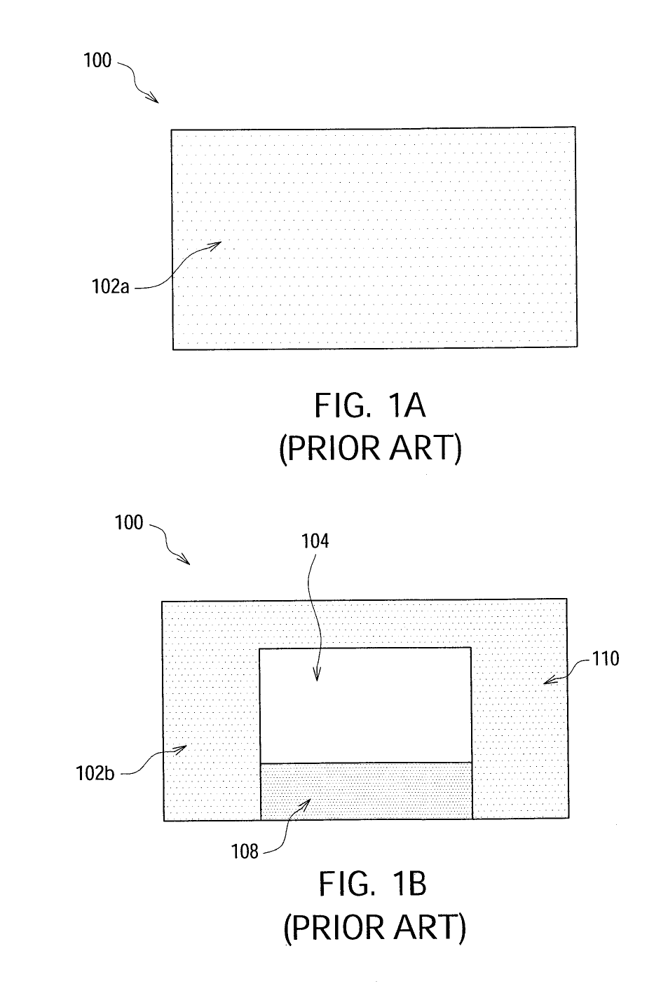

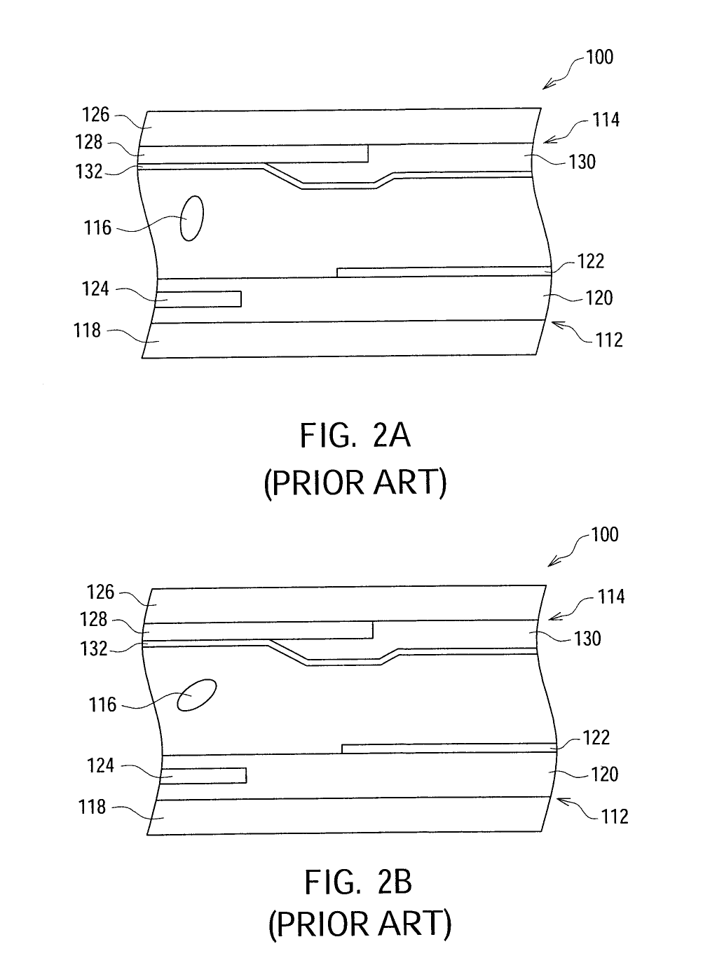

### DETAILED DESCRIPTION

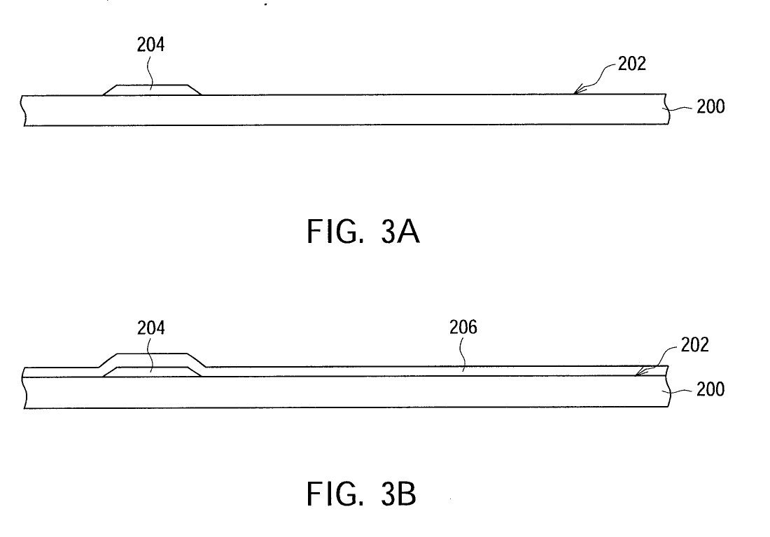

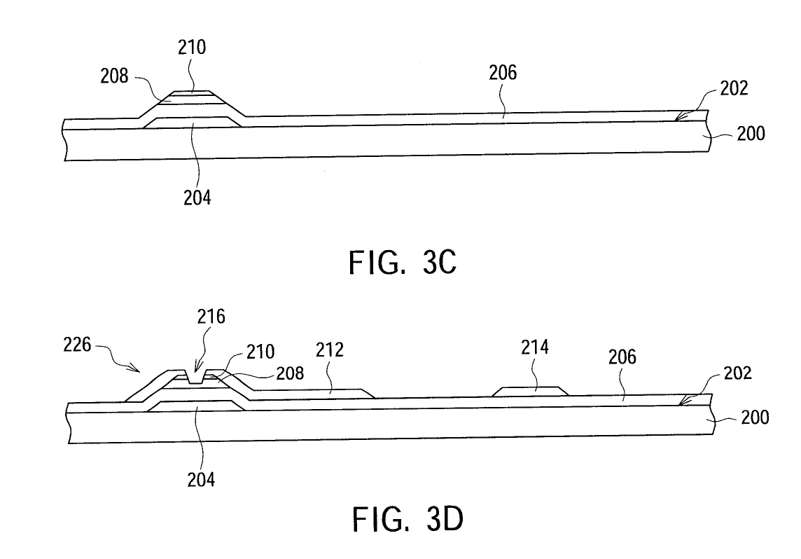

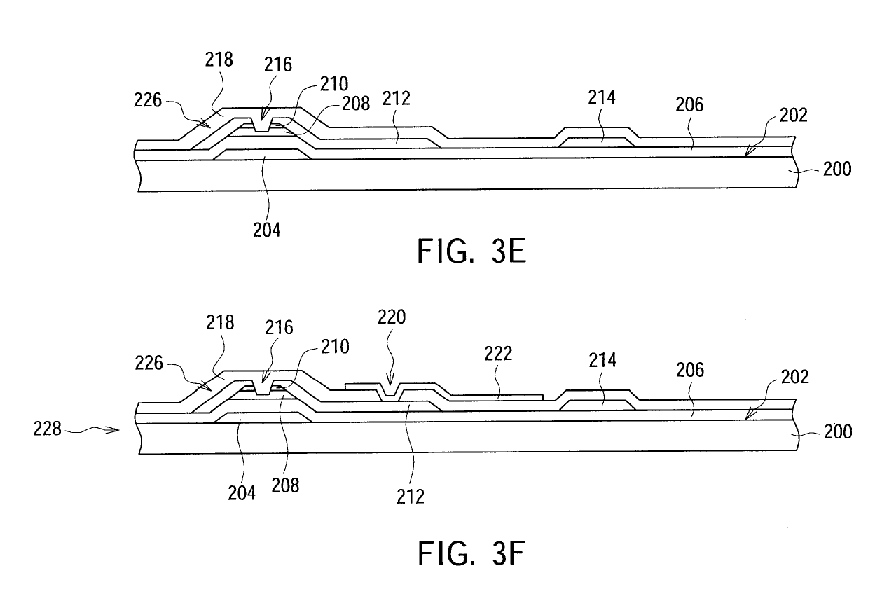

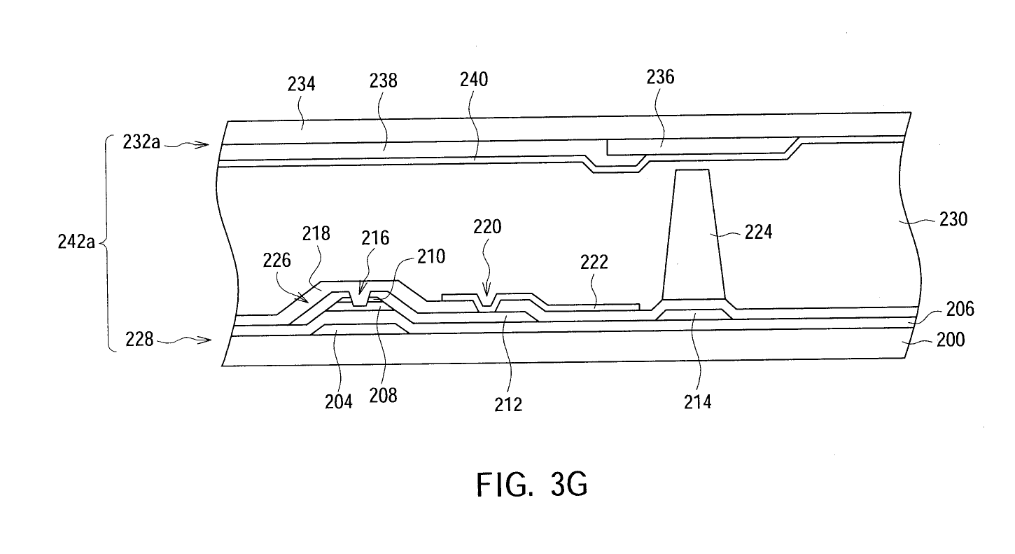

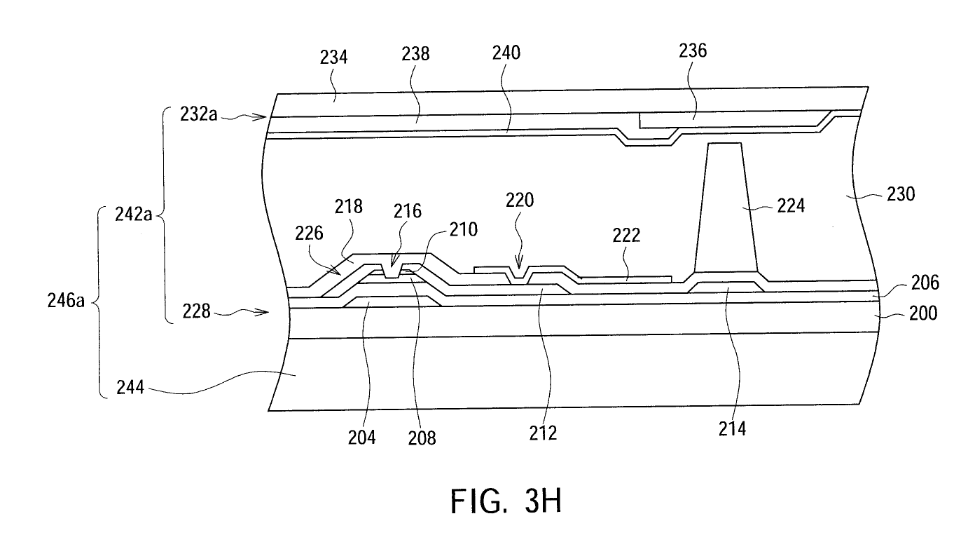

Referring to FIG. 3A through FIG. 3H. FIG. 3A through FIG. 3H are schematic flow diagrams showing a process for manufacturing a liquid crystal display in accordance with a first preferred embodiment of the present disclosure. Referring to FIG. 3H, a liquid crystal display 246a includes a liquid crystal panel 242a and a backlight module 244. In the present embodiment, when the liquid crystal display 246a is fabricated, the backlight module 244 is provided, and the liquid crystal panel 242a is disposed above the backlight module 244 to form the liquid crystal display 246a. When the liquid crystal panel 242a is fabricated, a transistor substrate 228 is fabricated and provided, and then a color filter 232a and a liquid crystal layer 230 are disposed on the transistor substrate 228, wherein the liquid crystal layer 230 is placed in between the color filter 232a and the transistor substrate 228. In the present exemplary embodiment, the liquid crystal panel 242a further includes a plurality of spacer structures 224 between data lines 214 of the transistor substrate 228 and the color filter 232a.

In the fabrication of the transistor substrate 228, as shown in FIG. 3A, a transparent substrate 200, such as a glass substrate, is provided. A gate 204 is formed on a surface 202 of the transparent substrate 200 by, for example, a deposition technique and a patterning technique, such as photolithography and etching. The gate 204 may be composed of metal, for example. Then, as shown in FIG. 3B, an insulation layer 206 is deposited to cover the surface 202 of the transparent substrate 200 and the gate 204. As shown in FIG. 3C, an amorphous silicon layer 208 is formed on the insulation layer 206 above the gate 204, and then an n⁺ amorphous silicon layer 210 is formed to stack on the amorphous silicon layer 208.

Next, as shown in FIG. 3D, a metal layer (only a source/drain layer 212 and the data lines 214 of the metal layer are illustrated) is deposited to cover the insulation layer 206, the amorphous silicon layer 208 and the n⁺ amorphous silicon layer 210. A pattern definition step is performed on the metal layer by a pattern definition technique, such as photolithography and etching, to form the source/drain layer 212 on the insulation layer 206, the amorphous silicon layer 208 and the n⁺ amorphous silicon layer 210 above the gate 204 and a plurality of data lines 214 on the insulation layer 206 beyond the region where the gate 204 is located. In the present exemplary embodiment, only one of the data lines 214 is shown for illustration. Next, a pattern definition step is performed on the stack structure composed of the source/drain layer 212, the n⁺ amorphous silicon layer 210 and the amorphous silicon layer 208 to remove a portion of the source/drain layer 212, the n⁺ amorphous silicon layer 210 and the amorphous silicon layer 208 until a portion of the amorphous silicon layer 208 is exposed, so that an opening 216 is formed in the stack structure composed of the source/drain layer 212, the n⁺ amorphous silicon layer 210 and the amorphous silicon layer 208 to define a source and a drain, thereby completing the fabrication of a thin film transistor 226.

As shown in FIG. 3E, a protective layer 218 is formed to cover the source/drain layer 212, the n⁺ amorphous silicon layer 210, the amorphous silicon layer 208 and the exposed insulation layer 206 and to fill the opening 216. As shown in FIG. 3F, the protective layer 218 is defined to form an opening 220 in the protective layer 218 by, for example, a photolithography and etching technique, wherein the opening 220 exposes a portion of the source/drain layer 212 of the thin film transistor 226. Next, a transparent electrode layer 222 is formed to cover a portion of the protective layer 218 and to cover a sidewall and a bottom of the opening 220 by a deposition method, so as to make the transparent electrode layer 222 contact with the portion of the source/drain layer 212 exposed by the opening 220 and form an electrical connection. At this point, the fabrication of the transistor substrate 228 is substantially completed. The transistor substrate 228 may be a thin film transistor (TFT) substrate, and the material of the transparent electrode layer 222 may be, for example, indium tin oxide.

Subsequently, as shown in FIG. 3G, the spacer structures 224 are formed on the protective layer 218 above a portion of the data line 214 by, for example, a deposition technique and a pattern definition technique, such as photolithography and/or etching. In one embodiment, the spacer structures 224 and photo spacers may be fabricated simultaneously by a typical photo spacer process. The material of the spacer structures 224 may be a low dielectric constant material or an organic material. A photoresist material may also be adopted as the material of the spacer structures 224. When the material of the spacer structures 224 is the photoresist material, the spacer structures 224 can be fabricated by using only a photolithography technique. When the material of the spacer structures 224 is not the photoresist material, the spacer structures 224 can be fabricated by deposition, photolithography and etching techniques. In one embodiment, the liquid crystal layer 230 may be disposed above the protective layer 218 and the transparent electrode layer 222 of the transistor substrate 228 and the spacer structures 224, and the color filter 232a is then disposed on the liquid crystal layer 230 to substantially complete the fabrication of the liquid crystal panel 242a. The spacer structures 224 are disposed on the transistor substrate 228, so that the step of disposing the spacer structures 224 is performed between the step of providing the transistor substrate 228 and the step of disposing the color filter 232a. The color filter 232a includes a transparent substrate 234, and a black matrix layer 236, a color resist layer 238 and a transparent electrode layer 240 disposed on a surface of the transparent substrate 234. The color resist layer 238 typically covers a portion of the black matrix layer 236, and the transparent electrode layer 240 covers the color resist layer 238 and the black matrix layer 236. The material of the transparent electrode layer 240 may be indium tin oxide. In another embodiment, the color filter 232a may be disposed above the transistor substrate 228, and the gap between the color filter 232a and the transistor substrate 228 is then filled with liquid crystal material to form the liquid crystal layer 230 placed in between the color filter 232a and the transistor substrate 228.

After the liquid crystal panel 242a is completed, the liquid crystal panel 242a is disposed on the backlight module 244 to place the backlight module 244 on the rear of the liquid crystal panel 242a, thereby substantially completing the fabrication of the liquid crystal display 246a, such as shown in FIG. 3H.

In the conventional liquid crystal panel, the relative dielectric permittivity component Ε// of the liquid crystal parallel to the electric field direction is about 3.4, and the relative dielectric permittivity component ε⊥ of the liquid crystal perpendicular to the electric field direction is about 5.2. In one embodiment of the present application, when the spacer structures 224 are composed of an analytic-based material, the relative dielectric constant of the analytic-based material is between about 3.2-3.6. Therefore, the parasitic capacitance of the liquid crystal panel 242a can be effectively decreased.

In addition, the gap between the data line 214 and the color filter 232a can be reduced by disposing the spacer structures 224 on the data line 214 of the transistor substrate 228, so that the change of the capacitance of the liquid crystal material in the liquid crystal layer 230 caused by the change of the voltage can be reduced, thereby improving the decrease of brightness issue on the region below the window region of the liquid crystal panel 242a. Thus, the display quality of the liquid crystal display 246 is enhanced.

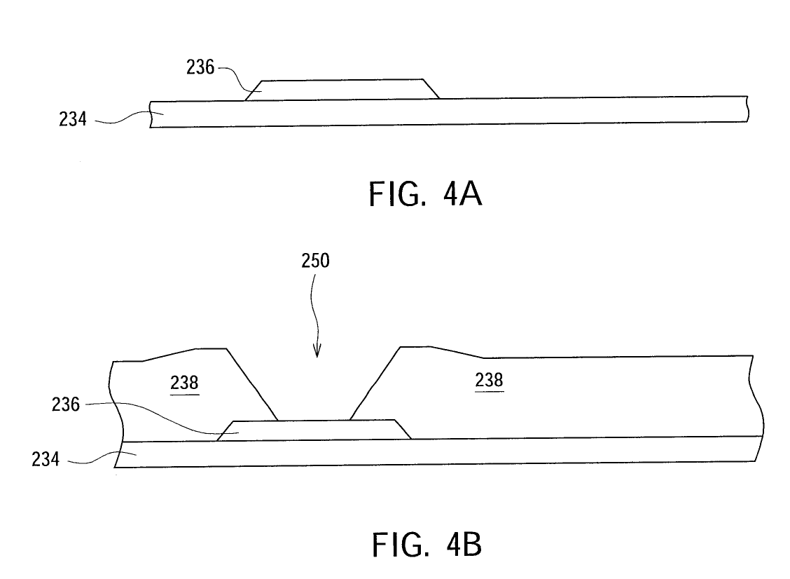

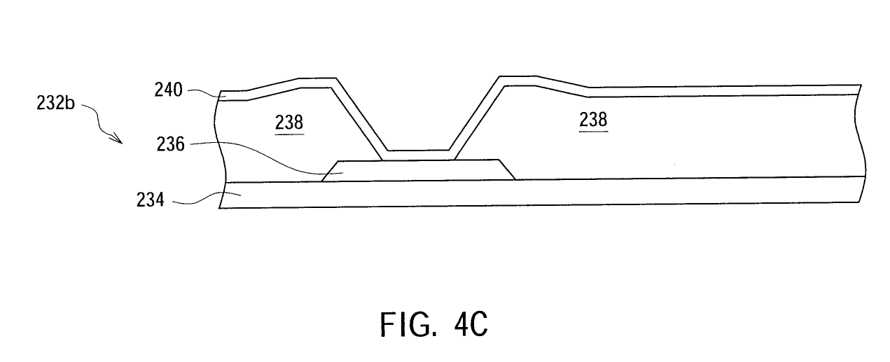

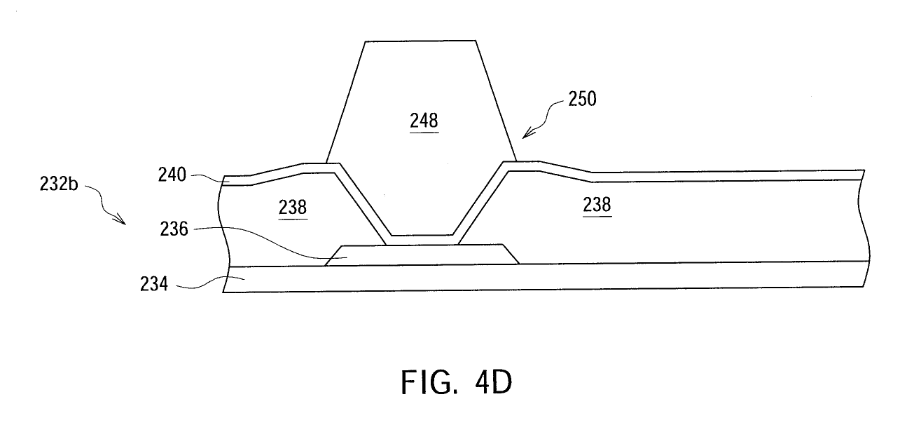

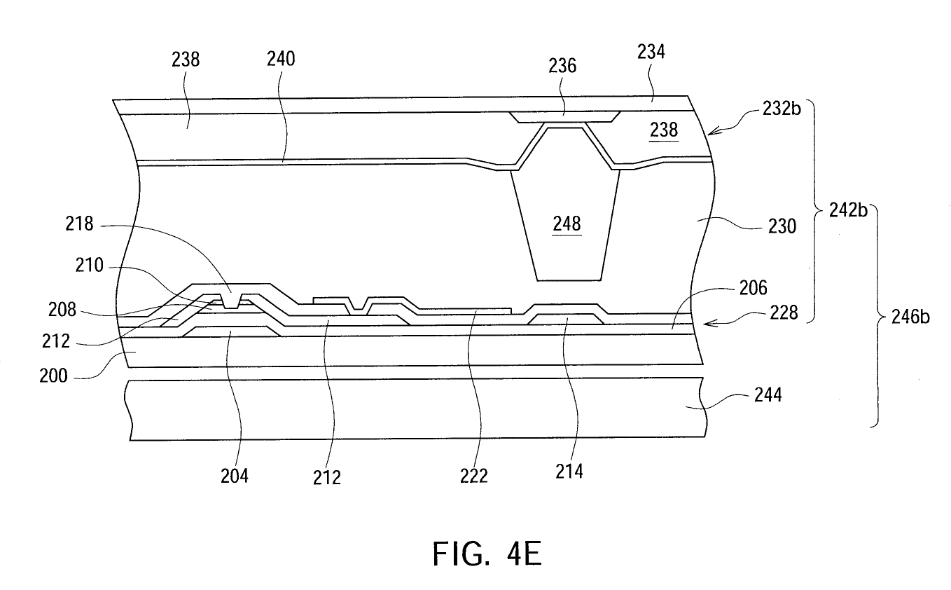

Referring to FIG. 4A through FIG. 4E. FIG. 4A through FIG. 4E are schematic flow diagrams showing a process for manufacturing a liquid crystal display in accordance with a second preferred embodiment of the present disclosure. Referring to FIG. 4E, a liquid crystal display 246b includes a liquid crystal panel 242b and a backlight module 244. In the present embodiment, when the liquid crystal display 246b is fabricated, the backlight module 244 is provided, and the liquid crystal panel 242b is disposed above the backlight module 244 to form the liquid crystal display 246b. When the liquid crystal panel 242b is fabricated, a transistor substrate 228 may be fabricated and provided as the description in the aforementioned first embodiment, and then a color filter 232b and a liquid crystal layer 230 are disposed on the transistor substrate 228, wherein the liquid crystal layer 230 is placed in between the color filter 232b and the transistor substrate 228. In the present exemplary embodiment, the liquid crystal panel 242b further includes a plurality of spacer structures 248 between data lines 214 of the transistor substrate 228 and the color filter 232b.

In the fabrication of the color filter 232b, as shown in FIG. 4A, a transparent substrate 234, such as a glass substrate, is provided. A black matrix layer 236 is formed on a surface of the transparent substrate 234 by, for example, a deposition technique and a patterning technique, such as photolithography. Next, as shown in FIG. 4B, a plurality of color resist layers 238 are formed to cover the transparent substrate 234 and a portion of the black matrix layer 236, and an opening 250 is formed on the black matrix layer 236 to expose another portion of the black matrix layer 236. The color resist layers 238 typically include photoresists of three colors, such as a red photoresist, a green photoresist and a blue photoresist. The color resist layers 238 of different colors are arranged according to the design of the product.

Then, as shown in FIG. 4C, a transparent electrode layer 240 is formed to cover the exposed portion of the black matrix layer 236 and the color resist layers 238, thereby substantially completing the fabrication of the color filter 232b. The material of the transparent electrode layer 240 may be indium tin oxide. Before the color filter 232b is disposed above the transistor substrate 228 (referring to FIG. 4E), a plurality of spacer structures 248 are formed on the transparent electrode layer 240 above the black matrix layer 236 of the color filter 232b by, for example, a deposition technique and a pattern definition technique, such as photolithography and/or etching. The spacer structures 248 fill up the openings 250 and protrude above the color resist layers 238, such as shown in FIG. 4D. In one embodiment, the spacer structures 248 and photo spacers may be fabricated simultaneously by a typical photo spacer process. The spacer structures 248 are opposite to the data lines 214 of the transistor substrate 228 to reduce the gap between the data lines 214 and the color filter 232b. The material of the spacer structures 248 may be a low dielectric constant material or an organic material. A photoresist material may also be adopted as the material of the spacer structures 248.

Then, in one embodiment, the liquid crystal layer 230 may be disposed above the protective layer 218 and the transparent electrode layer 222 of the transistor substrate 228, and the color filter 232b is then disposed on the liquid crystal layer 230 to substantially complete the fabrication of the liquid crystal panel 242b. In another embodiment, the color filter 232b may be disposed above the transistor substrate 228, and the gap between the color filter 232b and the transistor substrate 228 is then filled with liquid crystal material to form the liquid crystal layer 230 located in between the color filter 232b and the transistor substrate 228. After the liquid crystal panel 242b is completed, the liquid crystal panel 242b is disposed on the backlight module 244 to place the backlight module 244 on the rear of the liquid crystal panel 242b, thereby substantially completing the fabrication of the liquid crystal display 246b, such as shown in FIG. 4E.

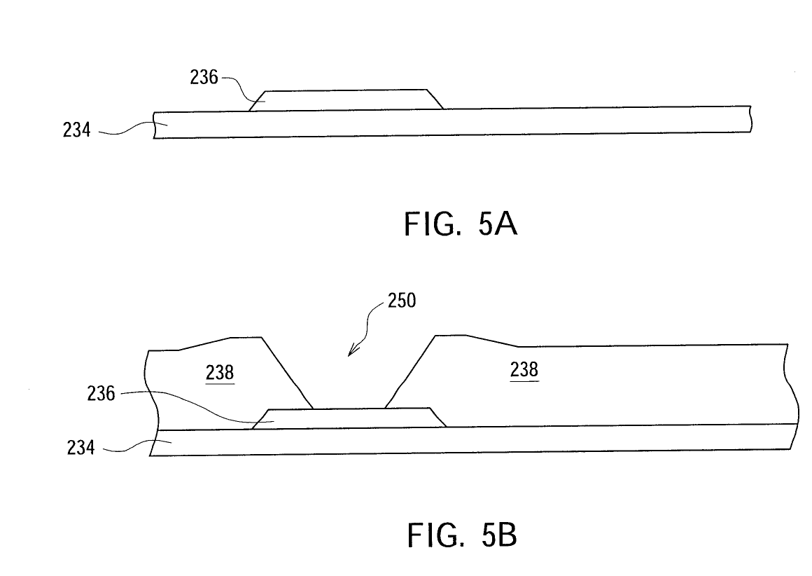

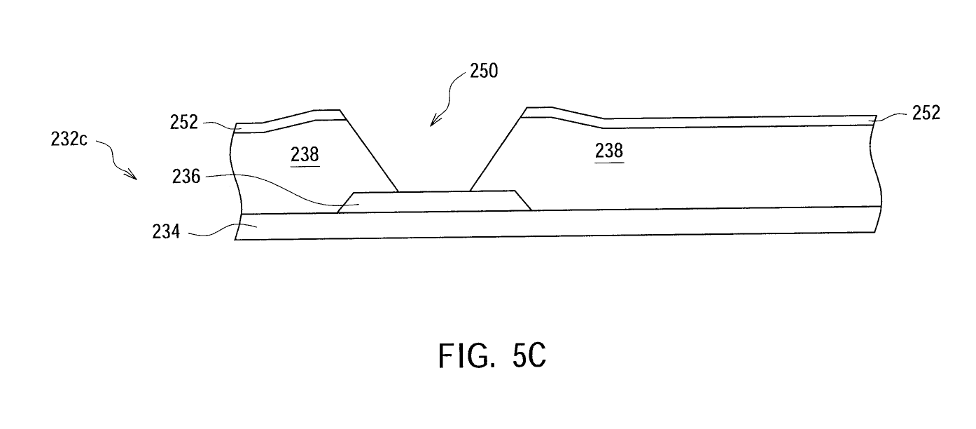

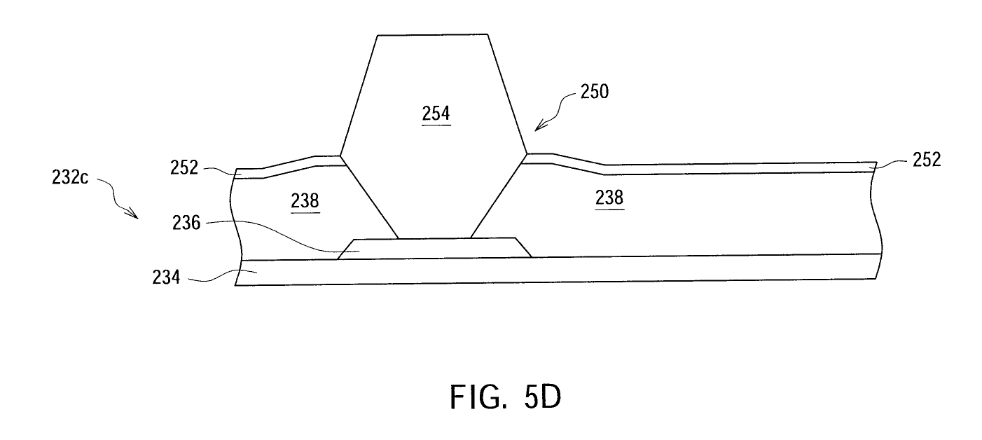

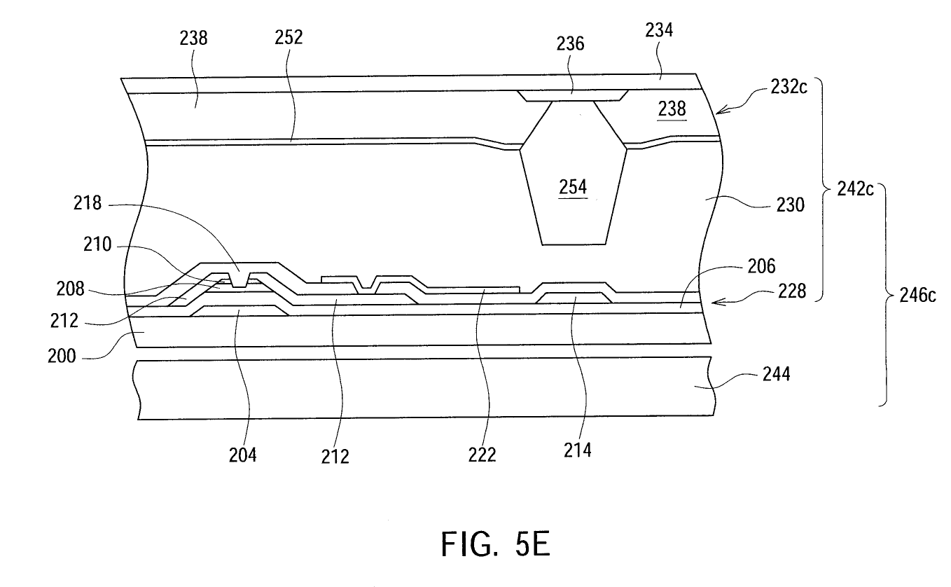

Referring to FIG. 5A through FIG. 5E. FIG. 5A through FIG. 5E are schematic flow diagrams showing a process for manufacturing a liquid crystal display in accordance with a third preferred embodiment of the present disclosure. Referring to FIG. 5E, a liquid crystal display 246c includes a liquid crystal panel 242c and a backlight module 244. In the present embodiment, when the liquid crystal display 246c is fabricated, the backlight module 244 is provided, and the liquid crystal panel 242c is disposed above the backlight module 244 to form the liquid crystal display 246c. When the liquid crystal panel 242c is fabricated, a transistor substrate 228 may be fabricated and provided as the description in the aforementioned first embodiment, and then a color filter 232c and a liquid crystal layer 230 are disposed on the transistor substrate 228, wherein the liquid crystal layer 230 is placed in between the color filter 232c and the transistor substrate 228. In the present exemplary embodiment, the liquid crystal panel 242c further includes a plurality of spacer structures 254 between data lines 214 of the transistor substrate 228 and the color filter 232c.

In the fabrication of the color filter 232c, as shown in FIG. 5A, a transparent substrate 234, such as a glass substrate, is provided. A black matrix layer 236 is formed on a surface of the transparent substrate 234 by, for example, a deposition technique and a patterning technique, such as photolithography. Next, as shown in FIG. 5B, a plurality of color resist layers 238 are formed to cover the transparent substrate 234 and a portion of the black matrix layer 236, and an opening 250 is formed on the black matrix layer 236 to expose another portion of the black matrix layer 236. The color resist layers 238 typically include photoresists of three colors, such as a red photoresist, a green photoresist and a blue photoresist. The color resist layers 238 of different colors are arranged according to the design of the product.

Then, as shown in FIG. 5C, a transparent electrode layer 252 is formed by a deposition technique and a patterning technique to cover a portion of the color resist layers 238 but not cover the black matrix layer 236 and the color resist layers 238 exposed by the opening 250, thereby substantially completing the fabrication of the color filter 232c. The exposed portion of the color resist layers 238 is located above the black matrix layer 236. The material of the transparent electrode layer 252 may be indium tin oxide. Before the color filter 232c is disposed above the transistor substrate 228 (referring to FIG. 5E), a plurality of spacer structures 254 are formed on the black matrix layer 236 and the color resist layers 238 on the black matrix layer 236 of the color filter 232c by, for example, a deposition technique and a pattern definition technique, such as photolithography and/or etching. The spacer structures 254 fill up the openings 250 and protrude above the color resist layers 238, such as shown in FIG. 5D. In one embodiment, the spacer structures 254 and photo spacers may be fabricated simultaneously by a typical photo spacer process. The spacer structures 254 are placed opposite to the data lines 214 of the transistor substrate 228 to reduce the gap between the data lines 214 and the color filter 232c. The material of the spacer structures 254 may be a low dielectric constant material or an organic material. A photoresist material may also be adopted as the material of the spacer structures 254.

Then, in one embodiment, the liquid crystal layer 230 may be disposed above the protective layer 218 and the transparent electrode layer 222 of the transistor substrate 228, and the color filter 232c is then disposed on the liquid crystal layer 230 to substantially complete the fabrication of the liquid crystal panel 242c. In another embodiment, the color filter 232c may be disposed above the transistor substrate 228, and the gap between the color filter 232c and the transistor substrate 228 is then filled with liquid crystal material to form the liquid crystal layer 230 located in between the color filter 232c and the transistor substrate 228. After the liquid crystal panel 242c is completed, the liquid crystal panel 242c is disposed on the backlight module 244 to place the backlight module 244 on the rear of the liquid crystal panel 242c, thereby substantially completing the fabrication of the liquid crystal display 246c, such as shown in FIG. 5E.

In the liquid crystal panel 242c, the transparent electrode layer 252 of the color filter 232c on the region opposite to the data lines 214 is removed, so that the parasitic capacitance of the liquid crystal panel 242c can be further reduced in comparison with the liquid crystal panel 242b shown in FIG. 4E.

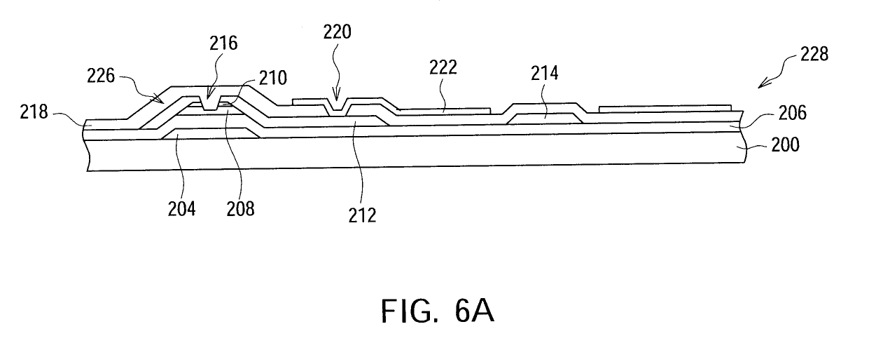

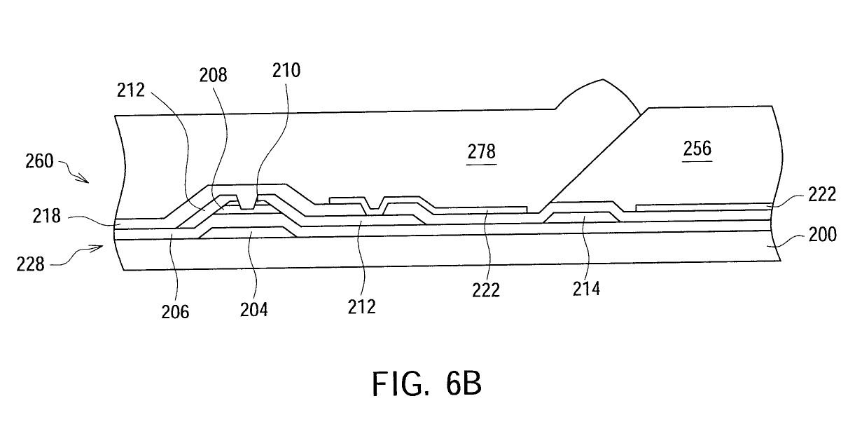

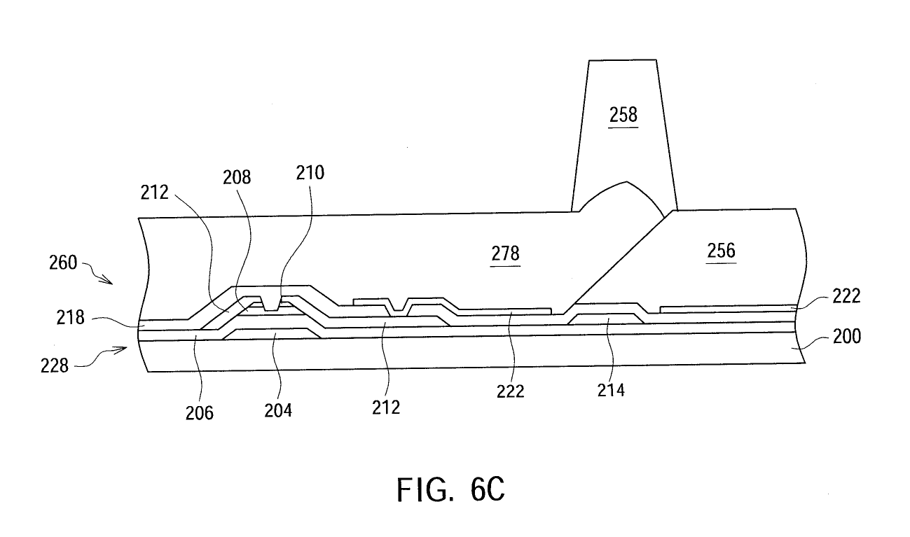

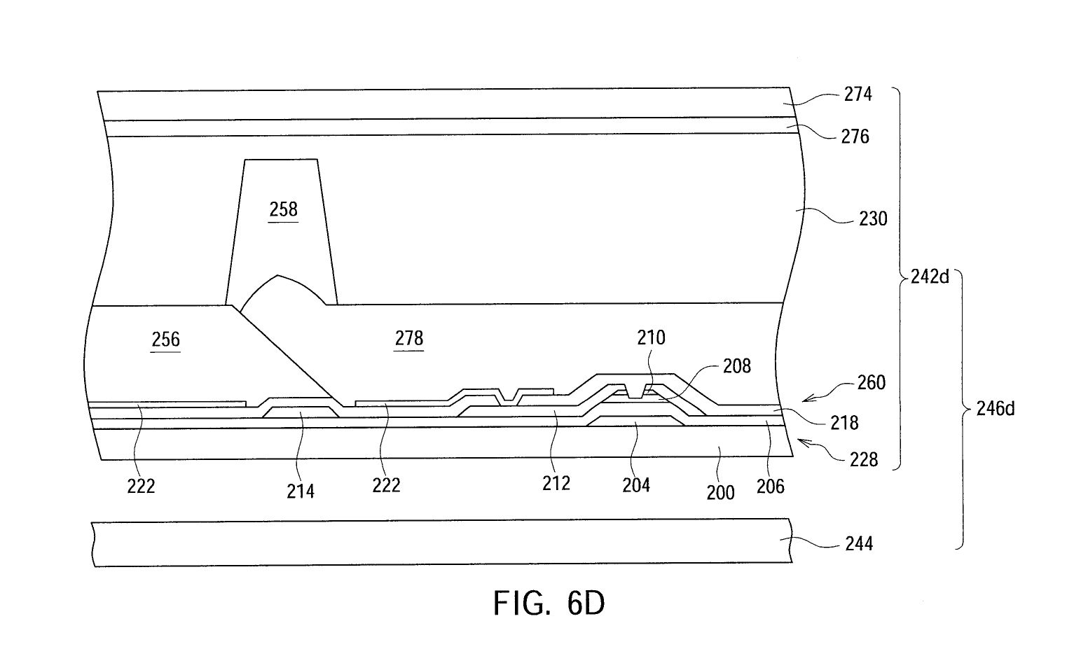

Referring to FIG. 6A through FIG. 6D. FIG. 6A through FIG. 6D are schematic flow diagrams showing a process for manufacturing a liquid crystal display in accordance with a fourth preferred embodiment of the present disclosure. Referring to FIG. 6D, a liquid crystal display 246d includes a liquid crystal panel 242d and a backlight module 244. In the present embodiment, when the liquid crystal display 246d is fabricated, the backlight module 244 is provided, and the liquid crystal panel 242d is disposed above the backlight module 244 to form the liquid crystal display 246d. When the liquid crystal panel 242d is fabricated, an integrated color filter 260 may be provided, a liquid crystal layer 230 is then disposed on the integrated color filter 260, and a transparent substrate 274 set with a transparent electrode layer 276 is disposed on the liquid crystal layer 230. The liquid crystal layer 230 is placed in between the integrated color filter 260 and the transparent electrode layer 276 of the transparent substrate 274. In the present exemplary embodiment, the liquid crystal panel 242d further includes a plurality of spacer structures 258 between data lines 214 of the transistor substrate 228 and the transparent electrode layer 276 of the transparent substrate 274.

In the fabrication of the integrated color filter 260, such as shown in FIG. 6A, a transistor substrate 228 may be firstly fabricated and provided as the description in the aforementioned first embodiment. As shown in FIG. 6B, a plurality of color resist layers 256 and 278 are disposed on a protective layer 218 and a transparent electrode layer 222 of the transistor substrate 228, thereby substantially completing the fabrication of the integrated color filter 260. The color resist layers 256 and 278 typically include photoresists of three colors, such as a red photoresist, a green photoresist and a blue photoresist. The color resist layers 256 and 278 of different colors are arranged according to the design of the product. In the present exemplary embodiment, the color resist layers 256 and 278 are distributed on the protective layer 218 and the transparent electrode layer 222 of the transistor substrate 228, and any two adjacent color resist layers 256 and 278 stack on the data lines 214 of the transistor substrate 228 and slightly protrude, such as the structure shown in FIG. 6B.

Before the liquid crystal layer 230 is disposed above the integrated color filter 260 (referring to FIG. 6D), a plurality of spacer structures 258 are formed on the stack of the adjacent color resist layers 256 and 278 above the data line 214 of the integrated color filter 260, such as shown in FIG. 6C, by a deposition technique and a pattern definition technique, such as photolithography and/or etching, for example. In one embodiment, the spacer structures 258 and photo spacers may be fabricated simultaneously by a typical photo spacer process. The material of the spacer structures 258 may be a low dielectric constant material or an organic material. A photoresist material may also be adopted as the material of the spacer structures 258.

Then, in one embodiment, the liquid crystal layer 230 may be firstly disposed above the color resist layers 256 and 278 of the integrated color filter 260 and the spacer structures 258, and the transparent substrate 274 set with the transparent electrode layer 276 is then disposed on the liquid crystal layer 230 to place the liquid crystal layer 230 in between the transparent electrode layer 276 of the transparent substrate 274 and the integrated color filter 260, thereby substantially completing the fabrication of the liquid crystal panel 242d. In another embodiment, the transparent substrate 274 may be disposed above the integrated color filter 260, and the gap between the transparent substrate 274 set with the transparent electrode layer 276 and the integrated color filter 260 is then filled with liquid crystal material to form the liquid crystal layer 230 located in between the transparent substrate 274 and the integrated color filter 260. After the liquid crystal panel 242d is completed, the liquid crystal panel 242d is disposed on the backlight module 244 to place the backlight module 244 on the rear of the liquid crystal panel 242d, thereby substantially completing the fabrication of the liquid crystal display 246d, such as shown in FIG. 6D.

The spacer structures 258 are disposed above the data line 214 of the transistor substrate 228, so that the space for storing the liquid crystal material above the data line 214 can be decreased. Therefore, the change of the capacitance of the liquid crystal material in the liquid crystal layer 230 caused by the change of the voltage can be reduced, so that the RC delay phenomenon of the data line 214 can be reduced, thereby reducing the problem of the brightness reduction on the region below the window region of the liquid crystal panel 242d. Thus, the display quality of the liquid crystal panel 242d is enhanced.

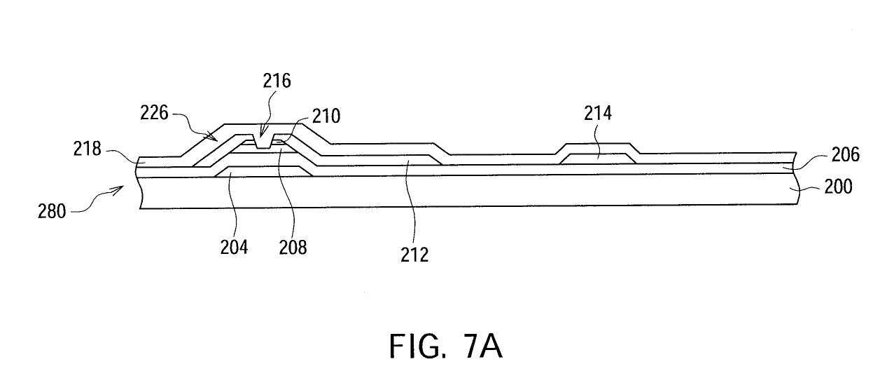

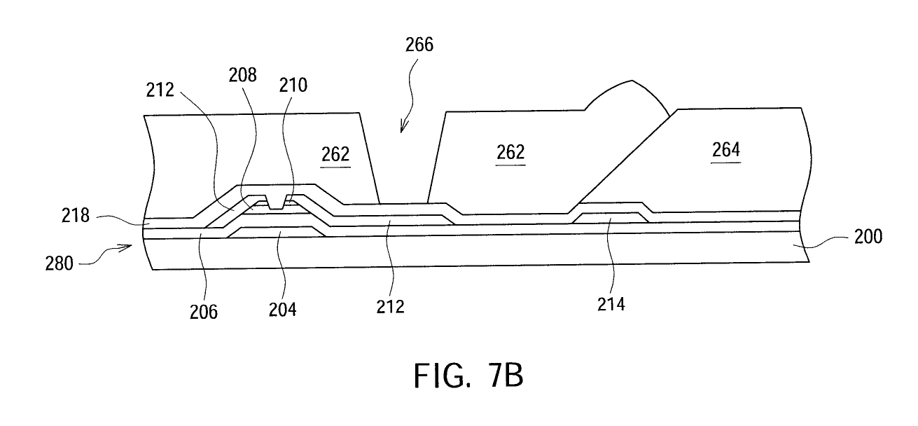

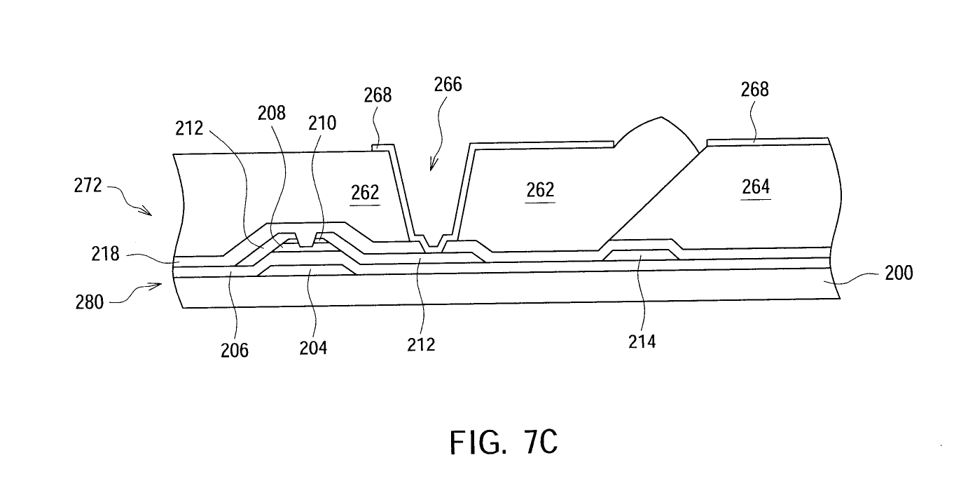

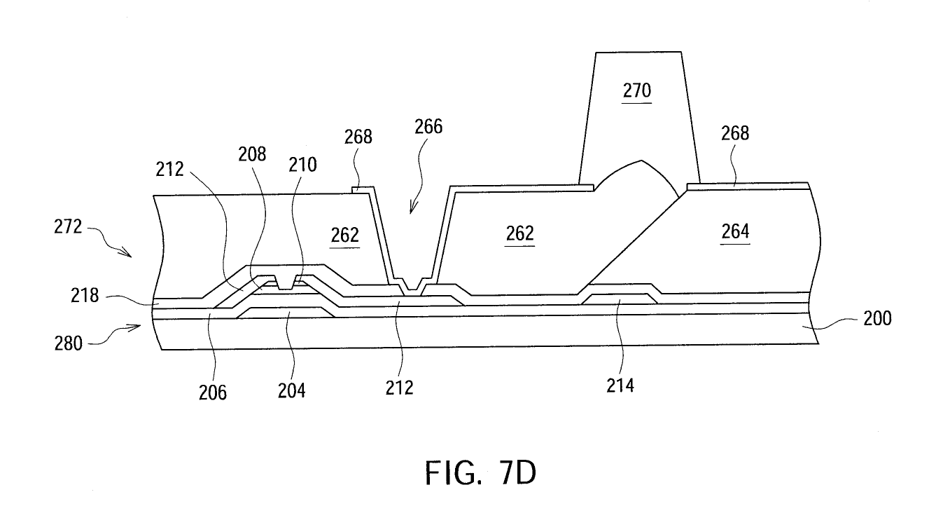

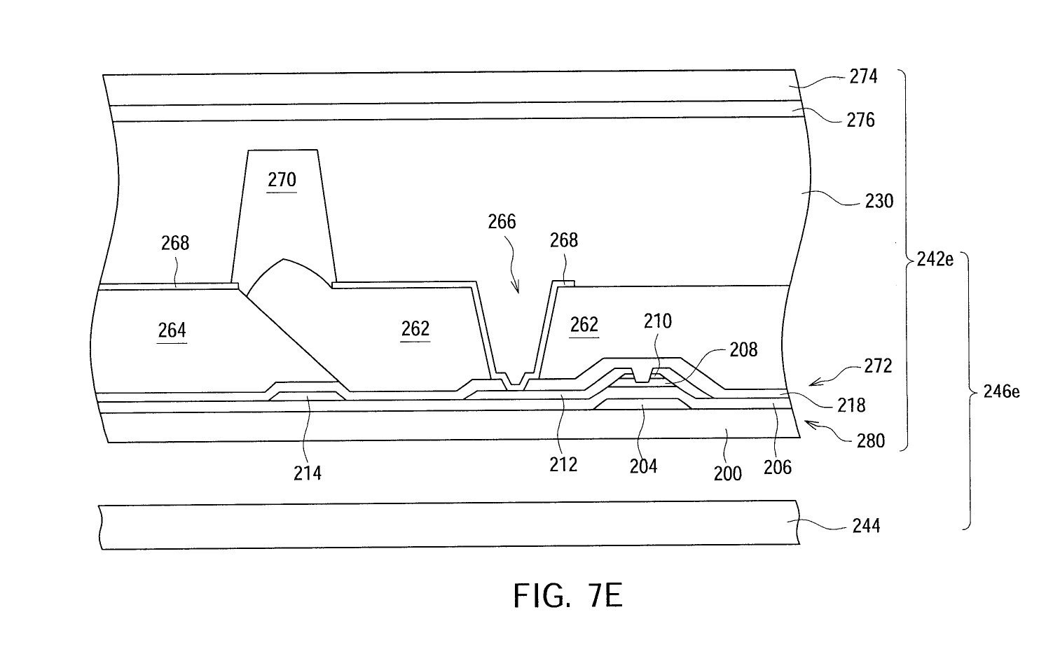

Referring to FIG. 7A through FIG. 7E. FIG. 7A through FIG. 7E are schematic flow diagrams showing a process for manufacturing a liquid crystal display in accordance with a fifth preferred embodiment of the present disclosure. Referring to FIG. 7E, a liquid crystal display 246e includes a liquid crystal panel 242e and a backlight module 244. In the present embodiment, when the liquid crystal display 246e is fabricated, the backlight module 244 is provided, and the liquid crystal panel 242e is disposed above the backlight module 244 to form the liquid crystal display 246e. When the liquid crystal panel 242e is fabricated, an integrated color filter 272 may be provided, a liquid crystal layer 230 is then disposed on the integrated color filter 272, and a transparent substrate 274 set with a transparent electrode layer 276 is disposed on the liquid crystal layer 230. The liquid crystal layer 230 is placed in between the integrated color filter 272 and the transparent electrode layer 276 of the transparent substrate 274. In the present exemplary embodiment, the liquid crystal panel 242e further includes a plurality of spacer structures 270 between data lines 214 of the integrated color filter 272 and the transparent electrode layer 276 of the transparent substrate 274.

In the fabrication of the integrated color filter 272, as shown in FIG. 7A, a transistor substrate 280 may be fabricated and provided as the description in the aforementioned first embodiment. The transistor substrate 280 is not the same as the transistor substrate 228 and is not set with the transparent electrode layer of the transistor substrate 228, but except for those features, the structure and each layer of the transistor substrate 280 are the same as those of the transistor substrate 228. As shown in FIG. 7B, a plurality of color resist layers 262 and 264 are disposed on a protective layer 218 of the transistor substrate 280. The color resist layers 262 and 264 typically include photoresists of three colors, such as a red photoresist, a green photoresist and a blue photoresist. The color resist layers 262 and 264 of different colors are arranged according to the design of the product. In the present exemplary embodiment, the color resist layers 262 and 264 are distributed on the protective layer 218 of the transistor substrate 280, and any two adjacent color resist layers 262 and 264 stack on the data lines 214 of the transistor substrate 280 and slightly protrude. As shown in FIG. 7B, an opening 266 is formed in the color resist layer 262 by a patterning technique, such as photolithography, wherein the opening 266 exposes a portion of the protective layer 218.

Next, a definition step is performed on a portion of the exposed portion of the protective layer 218 to remove a portion of the protective layer 218 and to make the opening 266 further expose a portion of the underlying source/drain layer 212. Then, as shown in FIG. 7C, a transparent electrode layer 268 is fowled by a deposition method and a photolithography and etching method to cover a portion of the color resist layers 262 and 264, a sidewall of the color resist layer 262, the protective layer 218 and the source/drain layer 212 exposed by the opening 266, such that the transparent electrode layer 268 contacts with the portion of the source/drain layer 212 exposed by the opening 266 and forms an electrical connection with the source/drain layer 212. The transparent electrode layer 268 does not cover the stack formed by the adjacent color resist layers 262 and 264 above the data line 214 of the transistor substrate 280. At this point, the fabrication of the integrated color filter 272 is substantially completed. The material of the transparent electrode layer 268 may be, for example, indium tin oxide.

Before the liquid crystal layer 230 is disposed above the integrated color filter 272 (referring to FIG. 7E), a plurality of spacer structures 270 are formed on the stack of the adjacent color resist layers 262 and 264 above the data line 214 of the integrated color filter 272, such as shown in FIG. 7D, by a deposition technique and a pattern definition technique, such as photolithography and/or etching, for example. In one embodiment, the spacer structures 270 and photo spacers may be fabricated simultaneously by a typical photo spacer process. The material of the spacer structures 270 may be a low dielectric constant material or an organic material. A photoresist material may also be adopted as the material of the spacer structures 270.

Then, in one embodiment, the liquid crystal layer 230 may be disposed above the color resist layers 262 and 264 of the integrated color filter 272, the transparent electrode layer 268 and the spacer structures 270, and the transparent substrate 274 set with the transparent electrode layer 276 is then disposed on the liquid crystal layer 230 to place the liquid crystal layer 230 in between the transparent electrode layer 276 of the transparent substrate 274 and the integrated color filter 272, thereby substantially completing the fabrication of the liquid crystal panel 242e. In another embodiment, the transparent substrate 274 may be disposed above the integrated color filter 272, and the gap between the transparent substrate 274 set with the transparent electrode layer 276 and the integrated color filter 272 is then filled with liquid crystal material to form the liquid crystal layer 230 located in between the transparent substrate 274 and the integrated color filter 272. After the liquid crystal panel 242e is completed, the liquid crystal panel 242e is disposed on the backlight module 244 to place the backlight module 244 on the rear of the liquid crystal panel 242e, thereby substantially completing the fabrication of the liquid crystal display 246e, such as shown in FIG. 7E.

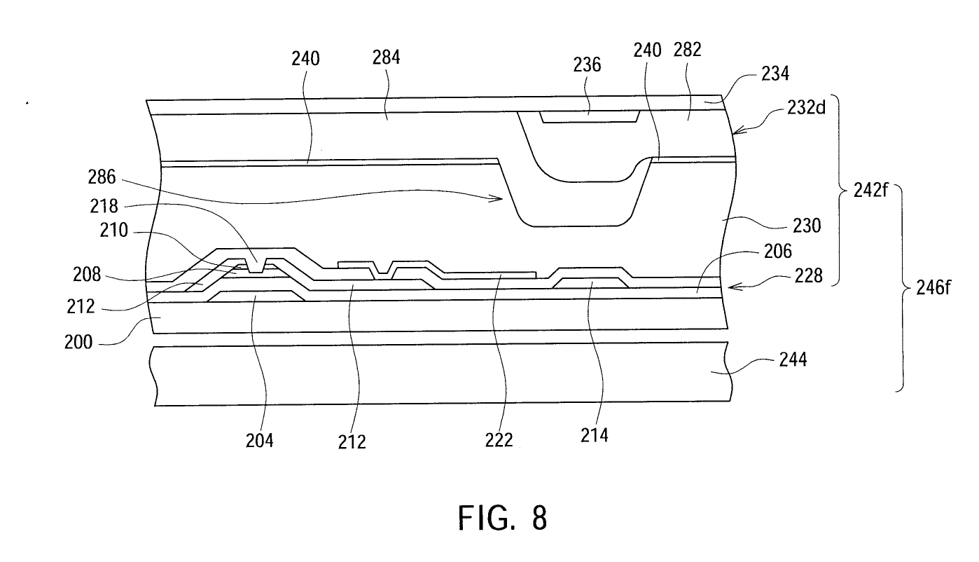

Referring to FIG. 8. FIG. 8 illustrates a cross-sectional view of a liquid crystal display in accordance with a sixth preferred embodiment of the present disclosure. The structure of a liquid crystal display 246f is substantially the same as the structure of the liquid crystal display 246b. The difference between the structures of the liquid crystal display 246f and 246b is that any two adjacent color resist layers 282 and 284 of a color filter 232d of the liquid crystal display 246f form a stack structure 286 on a region corresponding to the data line 214 of the transistor substrate 280. These stack structures 286 are used to replace the spacer structures 248 of the color filter 232b of the liquid crystal display 246b. The color resist layers 282 and 284 typically include photoresists of three colors, such as a red photoresist, a green photoresist and a blue photoresist. The color resist layers 282 and 284 of different colors are arranged according to the design of the product.

In another embodiment, when the liquid crystal panel needs higher spacer structures, each spacer structure may be a structure formed by stacking color resist layers of three colors.

In the present exemplary embodiment, by using any two adjacent color resist layers 282 and 284 to form the stack structure 286 on the side opposite to the data line 214, the space above the data line 214 can be effectively reduced without additionally disposing a spacer structure.

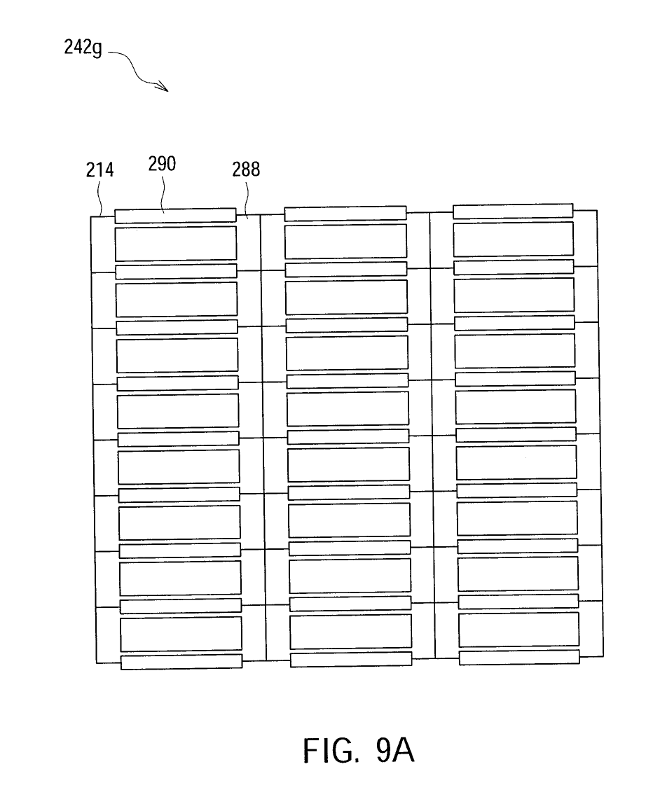

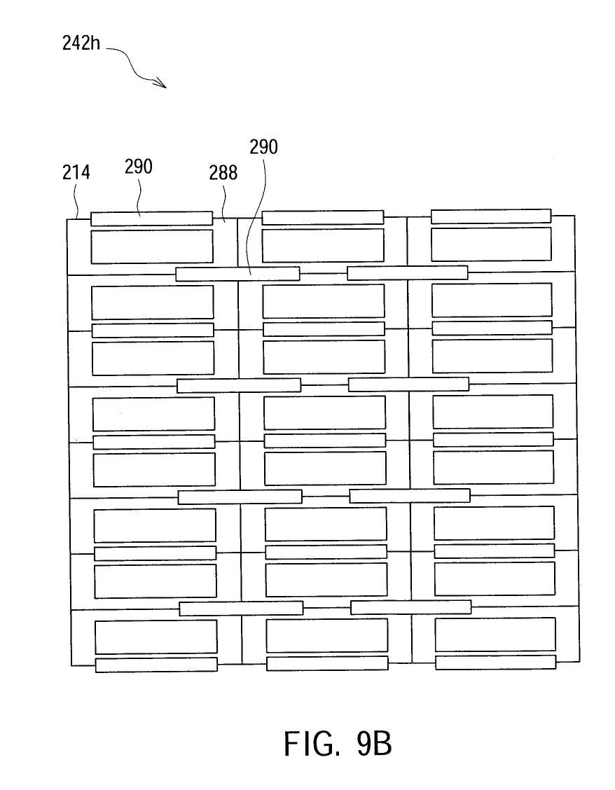

In the present disclosure, the spacer structures are distributed along the data lines of the liquid crystal panel and are strip-shaped. Referring to FIG. 9A and FIG. 9B. FIG. 9A and FIG. 9B are schematic diagrams showing dispositions of spacer structures in accordance with two embodiments of the present disclosure. A liquid crystal panel 242g includes a plurality of pixels 288 arranged in an array. As shown in FIG. 9A, the liquid crystal panel 242g further includes a plurality of spacer structures 290. The spacer structures 290 are strip-shaped and are arranged along the data lines 214 of the liquid crystal panel 242g. These spacer structures 290 are disposed between any two adjacent rows of the pixels 288 but are not stretched across two adjacent lines of the pixels 288, such as shown in FIG. 9A.

A liquid crystal panel 242h similarly includes a plurality of pixels 288 arranged in an array. As shown in FIG. 9B, the liquid crystal panel 242h also includes a plurality of spacer structures 290. The spacer structures 290 are strip-shaped and are arranged along the data lines 214 of the liquid crystal panel 242h similarly. These spacer structures 290 are disposed between any two adjacent rows of the pixels 288, wherein several rows of the spacer structures 290 are not stretched across two adjacent lines of the pixels 288, and the other rows of the spacer structures 290 are stretched across two adjacent lines of the pixels 288, such as shown in FIG. 9B.

According to the aforementioned preferred embodiments of the present disclosure, one advantage of the present disclosure is that in a liquid crystal panel and its application on a liquid crystal display, a plurality of spacer structures are disposed between data lines of a transistor substrate of the liquid crystal panel and a color filter, so that the gap between the data lines and the color filter can be decreased to reduce the change of the capacitance of the liquid crystal material caused by the change of the voltage, thereby improving the decrease problem of the brightness on the region below the window region of the liquid crystal panel.

According to the aforementioned preferred embodiments of the present disclosure, another advantage of the present disclosure is that in methods for manufacturing a liquid crystal panel and a liquid crystal display, a plurality of spacer structures are disposed between data lines of a transistor substrate of the liquid crystal panel and a color filter, or on color resist layers above data lines of an integrated color filter, to decrease the liquid crystal space above the data lines, thereby reducing the change of the capacitance of the liquid crystal material caused by the change of the voltage. Therefore, the RC delay phenomenon of the data lines can be greatly improved, thereby reducing the problem of the brightness decrease on the region below the window region of the liquid crystal panel, enhancing the display quality of the liquid crystal panel and the liquid crystal display.

As is understood by a person skilled in the art, the foregoing preferred embodiments of the present disclosure are illustrative of the present disclosure rather than limiting of the present disclosure. It is intended to cover various modifications and similar arrangements included within the spirit and scope of the appended claims, the scope of which should be accorded the broadest interpretation so as to encompass all such modifications and similar structure.

What is claimed is:

1. A liquid crystal panel, comprising:
a transistor substrate including a plurality of data lines;
a color filter disposed on the transistor substrate;
a liquid crystal layer disposed between the transistor substrate and the color filter; and
a plurality of spacer structures disposed between the data lines and the color filter.

2. The liquid crystal panel according to claim 1, wherein a material of the plurality of spacer structures is at least one of a low dielectric constant material or an organic material.

3. The liquid crystal panel according to claim 1, wherein the plurality of spacer structures is disposed on the transistor substrate.

4. The liquid crystal panel according to claim 1, wherein the transistor substrate further includes:
a transparent substrate, wherein the plurality of data lines is disposed on the transparent substrate;
a protective layer covering the transparent substrate and the plurality of data lines; and
the plurality of spacer structures is disposed on the protective layer above a portion of each one of the plurality of data lines.

5. The liquid crystal panel according to claim 1, wherein the plurality of spacer structures is disposed on the color filter.

6. The liquid crystal panel according to claim 1, wherein the color filter includes:
a transparent substrate;
a black matrix layer disposed on a portion of a surface of the transparent substrate; and
a plurality of color resist layers disposed on another portion of the surface of the transparent substrate and a portion of the black matrix layer.

7. The liquid crystal panel according to claim 6, wherein the plurality of spacer structures is disposed on the black matrix layer and the plurality of color resist layers is disposed on the black matrix layer.

8. The liquid crystal panel according to claim 6, wherein the color filter further includes a transparent electrode layer covering the plurality of color resist layers and the black matrix layer.

9. The liquid crystal panel according to claim 8, wherein the plurality of spacer structures is disposed on a portion of the transparent electrode layer above the black matrix layer.

10. The liquid crystal panel according to claim 6, wherein the color filter further includes a transparent electrode layer covering a portion of the plurality of color resist layers and exposing another portion of the plurality of color resist layers and the black matrix layer, wherein the plurality of spacer structures is disposed on the another portion of the plurality of color resist layers and the black matrix layer.

11. The liquid crystal panel according to claim 1, wherein each one of the plurality of spacer structures is distributed along one of the plurality of data lines and each one of the plurality of spacer structures is strip-shaped.

12. A liquid crystal panel, comprising:
a transistor substrate including a plurality of data lines;
a plurality of color resist layers distributed on the transistor substrate;
a plurality of spacer structures disposed on the plurality of color resist layers above the plurality of data lines; and
a liquid crystal layer disposed on the plurality of color resist layers and the plurality of spacer structures.

13. The liquid crystal panel according to claim 12, wherein a material of the plurality of spacer structures is at least one of a low dielectric constant material or an organic material.

14. The liquid crystal panel according to claim 12, wherein the transistor substrate further includes:
a transparent substrate, wherein the plurality of data lines is disposed on the transparent substrate;
a protective layer covering the transparent substrate and the plurality of data lines; and
a transparent electrode layer disposed on the protective layer.

15. The liquid crystal panel according to claim 14, wherein the transparent electrode layer is located between a portion of the protective layer and the plurality of color resist layers.

16. The liquid crystal panel according to claim 14, wherein the transparent electrode layer is located on a portion of the plurality of color resist layers.

17. The liquid crystal panel according to claim 13, wherein each one of the plurality of spacer structures is distributed along the data lines and each one of the plurality of spacer structures is strip-shaped.

18. A liquid crystal display, comprising:
a liquid crystal panel according to claim 1; and
a backlight module disposed on a rear of the liquid crystal panel.

19. A liquid crystal display, comprising:
a liquid crystal panel according to claim 12; and
a backlight module disposed on a rear of the liquid crystal panel.

20. A method for manufacturing a liquid crystal panel, comprising:
providing a transistor substrate, wherein the transistor substrate includes a plurality of data lines;
disposing a color filter on the transistor substrate;
disposing a liquid crystal layer between the transistor substrate and the color filter; and
disposing a plurality of spacer structures between the plurality of data lines and the color filter, each one of the plurality of spacer structures disposed above a portion of one of the plurality of data lines.
